(19) United States
(12) Patent Application Publication
(10) Pub. No.: US 2008/0174549 A1
(43) Pub. Date: Jul. 24, 2008

(54) Wireless cursor control device with image-tracking

(76) Inventor: Chi Wen Chen, Yonghe City (TW)

Correspondence Address: BACON & THOMAS, PLLC, 625 SLATERS LANE, FOURTH FLOOR, ALEXANDRIA, VA, 22314, US

(21) Appl. No.: 11/656,412

(22) Filed: Jan. 23, 2007

(51) Int. Cl. G06F 3/033

(52) U.S. Cl. 345/157

(57) ABSTRACT

A cursor control device is disclosed to include a fingering with a color mark for fastening to the user's one finger, a digital camera for scanning the color mark and to give an image signal to the computer indicative of direction and movement of the fingering, a wireless operating button device for fastening to the user's another finger and operable to transmit a control signal to the computer wirelessly, an image processing program installed in the computer for processing the image signal produced by the digital camera for moving the cursor on the display screen, and a button signal processing program installed in the computer for processing the control signal produced by the wireless operating button device and executing the respective command.

### BACKGROUND OF THE INVENTION

1. Field of the Invention

The present invention relates generally to a computer input device and more particularly, to a wireless cursor control device with image tracking for use to substitute a conventional computer mouse.

2. Description of the Related Art

FIG. 1 illustrates the use of a conventional wired optical computer mouse 1 with a laptop computer 2. The wired optical computer mouse 1 has sensor means adapted to detect the direction and amount of movement of the mouse 1 relative to the flat surface carrying the mouse 1 and to output a corresponding signal to the laptop computer 2 to control movement of the cursor on the display screen subject to the direction and amount of movement of the mouse, and operating buttons for pressing by the user to transmit a respective control signal to the computer 2, causing the computer 2 to execute a respective command. This structure of optical computer mouse is functional, however the muscles of the user's hand and arm operating the computer mouse will feel uncomfortable soon after a certain length of time in operating the computer mouse.

### SUMMARY OF THE INVENTION

The present invention has been accomplished under the circumstances in view. It is the main object of the present invention to provide a cursor control device, which is convenient in use to prevent muscle fatigue. It is another object of the present invention to provide a cursor control device, which controls the movement of the cursor subject to the direction and amount of movement of a color mark carried on the user's one finger by means of an image tracking technique.

To achieve these and other objects of the present invention, the cursor control device comprises a fingering with a color mark for fastening to the user's one finger, a digital camera for scanning the color mark and to give an image signal to the computer indicative of direction and movement of the fingering, a wireless operating button device for fastening to the user's another finger and operable to transmit a control signal to the computer wirelessly, an image processing program installed in the computer for processing the image signal produced by the digital camera for moving the cursor on the display screen, and a button signal processing program installed in the computer for processing the control signal produced by the wireless operating button device and executing the respective command.

Further, the color mark of the fingering is detachable, so that the color of the color mark is selectable subject to the background color of the work place to enhance the scanning accuracy.

### BRIEF DESCRIPTION OF THE DRAWINGS

FIG. 1 illustrates a conventional wired computer mouse connected to a laptop computer.

FIG. 2 is an elevational view of a fingering for cursor control device with image tracking according to the present invention.

FIG. 3 is an elevational view of a wireless operating button device for cursor control device with image tracking according to the present invention.

FIG. 4 is a schematic drawing showing the fingering and the wireless operating button device fastened to the user's index finger and middle finger according to the present invention.

FIG. 5 is an applied view of the cursor control device with image tracking according to the present invention.

FIG. 6 is an applied view of an alternate form of the cursor control device with image tracking according to the present invention.

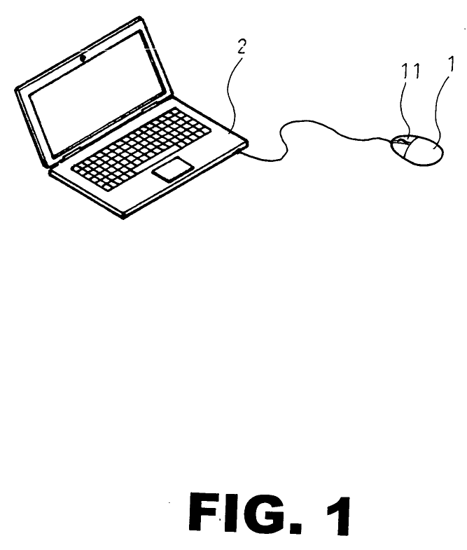

### DETAILED DESCRIPTION OF THE INVENTION

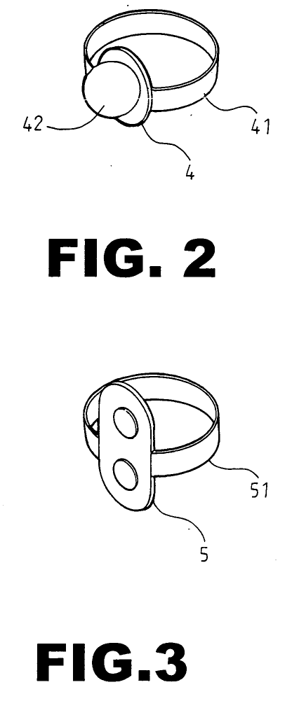

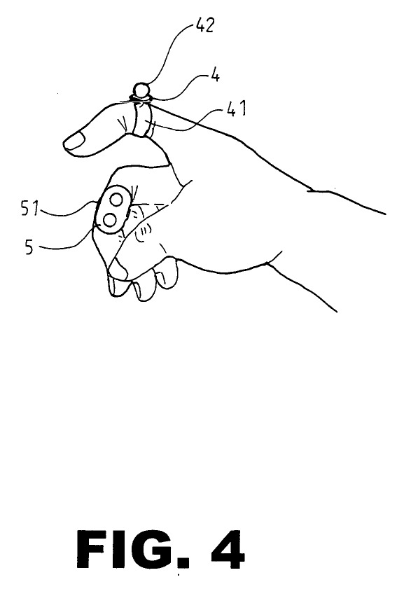

Referring to FIGS. 2˜5, a cursor control device with image tracking in accordance with the present invention is shown comprising a camera 3, a fingering 4, a wireless operating button device 5, and an image processing program and a button signal processing program installed in a computer 6.

The camera 3 can be a webcam installed in the computer 6, or a small-size digital camera externally connected to the computer 6 with a cable.

The fingering 4 comprises a band 41 for fastening to the user's one finger, and a setting carrying a color mark 42.

The wireless operating button device 5 has band 51 for fastening to the user's another finger.

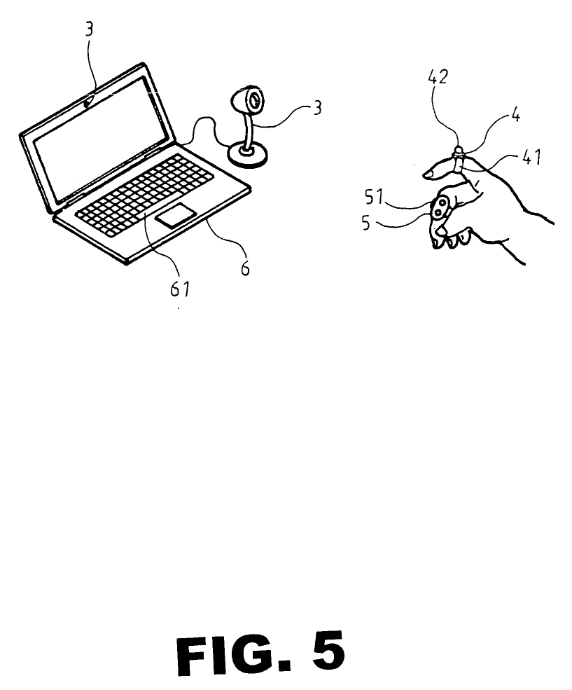

Referring to FIG. 5, the fingering 4 and the wireless operating button device 5 are respectively fastened to the user's index finger and middle finger. During operation, the user aims the color mark 42 of the fingering 4 at the lens of the camera 3 and moves the fingering 4 to control the moving amount and direction of the cursor on the display screen of the computer 6. When the user moves the fingering 4 relative to the camera 3, the camera 3 tracks the movement of the fingering 4 and produces a corresponding image signal to the computer 6 indicative of the direction and amount of the movement of the fingering 4, thereby causing the image processing program of the computer 6 to process the image signal so that the computer moves the cursor on the display screen subject to the direction and amount of the movement of the fingering 4. The wireless operating button device 5 provides the left button and right button functions of a regular computer mouse. When the user pressed the left button or right button on the wireless operating button device 5, a corresponding control signal is inputted into the computer 6 wirelessly, causing the button signal processing program of the computer 6 to process the signal and to execute the respective command. Alternatively, the user can operate the keyboard 61 of the computer 6 to input a common into the computer 6 instead of the wireless operating button device 5.

When the image processing program processes the image signal received from the camera 3, a low pass filtering or delay processing is needed to prevent executing of a false signal caused by accidental vibration of the finger carrying the fingering 4. Further, the color mark 42 of the fingering 4 is datable so that different color mark can be selectively fastened to the setting of the fingering 4 to show a significant color contrast relative to the color of the surrounding (i.e. the color of the table carrying the computer 6), thereby enhancing the accuracy of the operation of the camera 3 in scanning the motion of the fingering 4.

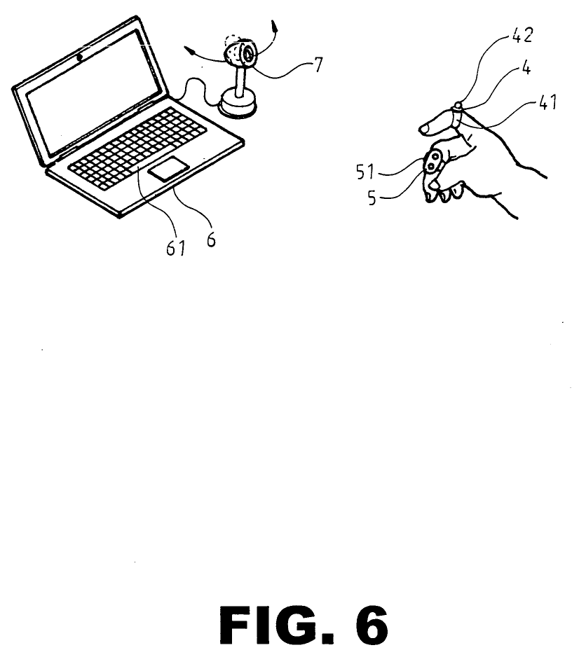

FIG. 6 shows an alternate form of the present invention. According to this embodiment, the camera 7 is a programmable camera that can be controlled to automatically adjust its scanning direction. Before use, the camera 7 automatically controls its scanning direction, and automatically sets the color mark 42 of the fingering 4 in its focus. Therefore, the camera 7 can quickly scan the image of the color mark 42 and tracks the motion of the fingering 4.

A prototype of wireless cursor control device with image tracking has been constructed with the features of FIGS. 2˜6. The wireless cursor control device with image tracking functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cursor control device installed in a computer for controlling movement of a cursor on a display screen of said computer, the cursor control device comprising:
a fingering for fastening to the user's one finger, said fingering carrying a color mark;
a digital camera adapted to scan said color mark and to give an image signal to said computer indicative of direction and movement of said fingering;
a wireless operating button device for fastening to the user's another finger and operable to transmit a control signal to said computer wirelessly;
an image processing program installed in said computer and adapted to process the image signal produced by said digital camera and to further drive said computer to move the cursor on the display screen subject to the direction and amount of the movement of said fingering; and
a button signal processing program installed in said computer and adapted to process the control signal produced by said wireless operating button device and to execute the respective command.

2. The cursor control device as claimed in claim 1, wherein said digital camera is programmable to automatically control the scanning direction of said digital camera and to automatically set the color mark of said fingering in the focus of said digital camera.

3. The cursor control device as claimed in claim 1, wherein said color mark of said fingering is detachable.

4. The cursor control device as claimed in claim 1, wherein said image processing program processes the image signal received from said digital camera through one of a low pass filtering process and a delay processing process to prevent executing of a false signal caused by accidental vibration of the finger carrying said fingering.

5. The cursor control device as claimed in claim 1, wherein image processing program controls the cursor on the display screen of said computer subject to the location of said color mark or the amount of movement of said color mark.
